(19) United States
(12) Patent Application Publication
(10) Pub. No.: US 2025/0030067 A1
(43) Pub. Date: Jan. 23, 2025

(54) CHARGING METHOD AND CHARGING SYSTEM

(71) Applicant: TOYOTA JIDOSHA KABUSHIKI KAISHA, Toyota-shi (JP)

(72) Inventor: Kazuki IWAMA, Nisshin-shi (JP)

(73) Assignee: TOYOTA JIDOSHA KABUSHIKI KAISHA, Toyota-shi (JP)

(21) Appl. No.: 18/760,726

(22) Filed: Jul. 1, 2024

(30) Foreign Application Priority Data
Jul. 21, 2023 (JP) 2023-119179

(51) Int. Cl. H01M 10/44; B60L 53/62; H02J 7/00

(52) U.S. Cl. CPC H01M 10/44; H02J 7/00714; B60L 53/62

(57) ABSTRACT

A charging method includes: determining, for charging current of a lithium ion battery, first and a second threshold values each representing a current boundary value at which precipitation of lithium metal becomes likely to occur on an electrode of the lithium ion battery; and controlling the charging current of the lithium ion battery using a difference between the first and second threshold values, and the second threshold value. The first threshold value represents a current boundary value at which precipitation of the lithium metal becomes likely to occur when the charging current of the lithium ion battery exceeds the first threshold value. The second threshold value is 10 smaller than the first threshold value, and represents a current boundary value at which precipitation of the lithium metal becomes likely to occur when the charging current of the lithium ion battery continuously exceeds the second threshold value.

### CROSS REFERENCE TO RELATED APPLICATIONS

This nonprovisional application is based on Japanese Patent Application No. 2023-119179 filed on Jul. 21, 2023 with the Japan Patent Office, the entire contents of which are hereby incorporated by reference.

### BACKGROUND

### Field

The present disclosure relates to a charging method and a charging system.

### Description of the Background Art

Japanese Patent Laying-Open No. 2012-016263 discloses a technique in which a Li precipitation start voltage (a voltage at which precipitation of lithium metal starts inside the cell) is set according to a first charging current or a first charging power of the cell, and when a terminal voltage of the cell reaches the Li precipitation start voltage, the first charging current or the first charging power is switched to a smaller second charging current or second charging power. The larger the first charging current or the first charging power is, the lower the Li precipitation start voltage is set.

### SUMMARY

In the technique described in Japanese Patent Laying-Open No. 2012-016263, since the charging current is lowered after the terminal voltage of the cell reaches the Li precipitation start voltage, precipitation of lithium metal may not be sufficiently suppressed. In particular, when the performance of the charger is low, the response of the charging current control by the charger is likely to be slow with respect to the change in the target charging current value. In the charging control using such a charger, a decrease in the charging current is delayed, and precipitation of lithium metal is likely to occur.

The present disclosure was made to solve the problem above, and an object thereof is to facilitate accurately suppressing precipitation of lithium metal in charging of a lithium ion battery.

A charging method according to one aspect of the present disclosure includes: determining, for charging current of a lithium ion battery, a first threshold value and a second threshold value each representing a current boundary value at which precipitation of lithium metal becomes likely to occur on an electrode of the lithium ion battery; and controlling the charging current of the lithium ion battery using a difference between the first threshold value and the second threshold value, and the second threshold value. The first threshold value represents a current boundary value at which precipitation of the lithium metal becomes likely to occur when the charging current of the lithium ion battery exceeds the first threshold value. The second threshold value is smaller than the first threshold value, and represents a current boundary value at which precipitation of the lithium metal becomes likely to occur when the charging current of the lithium ion battery continuously exceeds the second threshold value.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram illustrating a charging system according to an embodiment of the present disclosure.

FIG. 2 is a flowchart illustrating a charging method according to an embodiment of the present disclosure.

FIG. 3 is a time chart showing an operation example of the charging method shown in FIG. 2.

FIG. 4 is a diagram showing a modification of the charging system shown in FIG. 1.

### DESCRIPTION OF THE PREFERRED EMBODIMENTS

Embodiments of the present disclosure will be described in detail below with reference to the drawings. The same or corresponding elements in the drawings have the same reference characters allotted and description thereof will not be repeated.

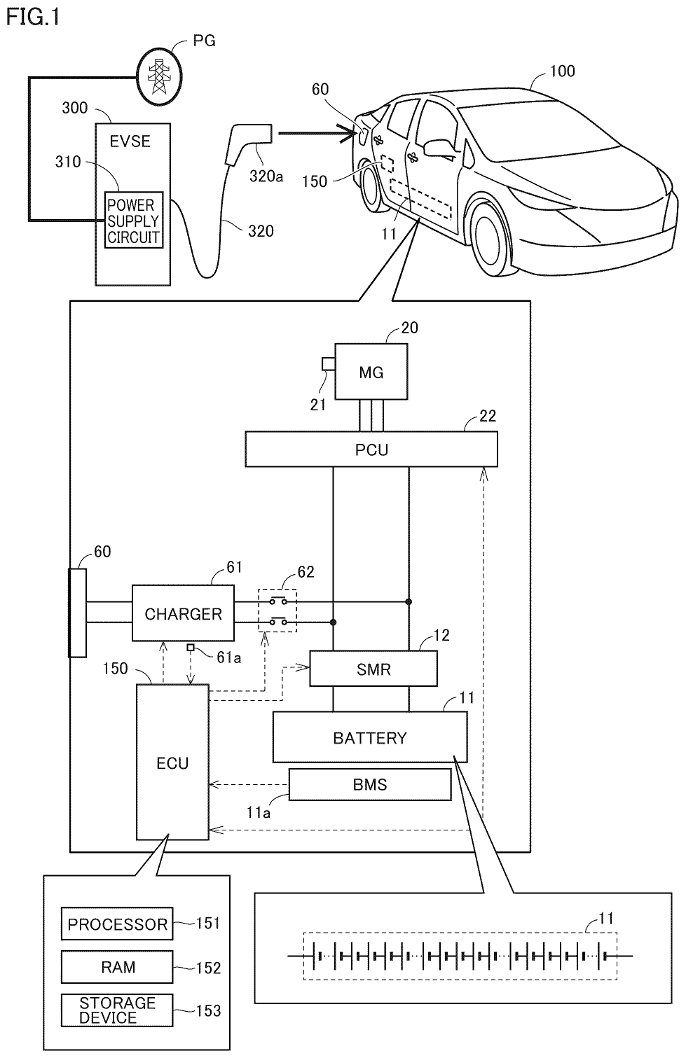

FIG. 1 is a diagram illustrating a charging system according to an embodiment of the present disclosure. Referring to FIG. 1, the charging system according to the present embodiment includes a vehicle 100 and an EVSE 300. The EVSE 300 is supplied with power from the power grid PG. EVSE (Electric Vehicle Supply Equipment) means a power supply facility for vehicles. The power grid PG is an electric power network constructed by electric power transmission and distribution facilities. A plurality of power plants (not shown) are connected to the power grid PG. The power grid PG is supplied with power from the power plants. In this embodiment, the power grid PG supplies AC power.

The EVSE 300 incorporates a power supply circuit 310 and includes a charging cable 320. The power supply circuit 310 is electrically connected to the power grid PG. The charging cable 320 has a connector 320a (plug) at its tip, and includes a communication line and a power line therein. One wire may serve as both a communication line and a power line. Power supply circuit 310 converts power supplied from power grid PG into power suitable for power supply to vehicle 100, and outputs the converted power to charging cable 320. The EVSE 300 outputs AC power from the connector 320a.

The vehicle 100 includes the inlet 60 to which the connector 320a is detachable. When the connector 320a of the charging cable 320 connected to the main body of the EVSE 300 is connected to the inlet 60 of the vehicle 100 in the parked state, the vehicle 100 is electrically connected to the power grid PG via the EVSE 300 (hereinafter also referred to as a “plug-in state”). On the other hand, for example, while the vehicle 100 is traveling, the vehicle 100 is not electrically connected to each of the EVSE 300 and the power grid PG (hereinafter, also referred to as a “plug-out state”).

The vehicle 100 further includes a battery 11, a system main relay (SMR) 12, a motor generator (MG) 20, a power control unit (PCU) 22, and ECU (Electronic Control Unit) 150. The ECU 150 includes a processor 151, a random access memory (RAM) 152, and a storage device 153. The storage device 153 is configured to store written information. The storage device 153 stores, in addition to a program, information used in the program (for example, a map, a mathematical expression, and various parameters). In this embodiment, the processor 151 executes a program stored in the storage device 153 to execute various controls (for example, charge control of the battery 11) in the ECU 150. However, these processes may be executed only by hardware (electronic circuit) without using software. The ECU 150 according to the present embodiment corresponds to an example of a “controller” according to the present disclosure.

The vehicle 100 is configured to be able to travel using electric power stored in the battery 11. The vehicle 100 is, for example, a battery electric vehicle (BEV) that does not include an engine (internal combustion engine). Without being limited as such, the vehicle 100 may be a plug-in hybrid electric vehicle (PHEV) including an internal combustion engine, or may be another electrically powered vehicle (xEV).

In this embodiment, the battery 11 is a battery assembly. The battery assembly is configured by electrically connecting a plurality of secondary batteries (generally referred to as “cells”) to each other. Each cell constituting the battery assembly is a lithium-ion secondary battery.

The cell comprises a positive electrode, a negative electrode, an electrolyte (e.g., a non-aqueous electrolyte solution), and a separator. For example, a stack of a sheet-like positive electrode, a sheet-like negative electrode, and a sheet-like separator is wound to form a wound body in which the electrodes and the separators are alternately arranged. The separator is interposed between the positive electrode sheet and the negative electrode sheet. The positive electrode sheet includes a positive electrode current collector (e.g., aluminum foil) and a positive electrode active material layer. Examples of the positive electrode active material include lithium ion-containing transition metal oxides (such as NCM, LFP, and LMFP). In this embodiment, an NCM system (a ternary system of nickel-cobalt-manganese) is employed as the positive electrode active material. The negative electrode sheet includes a negative electrode current collector (for example, copper foil) and a negative electrode active material layer. Examples of the negative electrode active material include a carbon-based material, a silicon-containing carbon-based material, silicon, lithium titanate (LTO), and niobium titanium oxide (NTO). In this embodiment, a carbon-based material (for example, graphite) is employed as the negative electrode active material. The negative electrode is a carbon-based electrode. Each of the active material layers of the positive electrode and the negative electrode is formed, for example, by applying a composite material containing an active material to the surface of a current collector. In this embodiment, the positive electrode and the negative electrode have a monopolar structure. Without being limited as such, the positive electrode and the negative electrode may have a bipolar structure.

The above-described wound body (stack) is sealed in a battery case together with an electrolyte solution. The positive electrode current collector is electrically connected to the positive electrode terminal. The negative electrode current collector is electrically connected to the negative electrode terminal. For example, a battery 11 (battery assembly) is formed by connecting a plurality of cells having such a configuration in series as shown in FIG. 1. However, the connection mode of the cells in the battery assembly is not limited to series connection, and may include parallel connection.

The battery 11 is provided with BMS (Battery Management System) 1la for monitoring the state of the battery 11. The BMS 11a includes various sensors that detect the state (for example, voltage, current, and temperature) of the battery 11, and a monitoring IC (integrated circuit) to which detection signals from the various sensors are input. In this embodiment, a voltage sensor and a temperature sensor are provided for each cell constituting the battery 11 (battery assembly). Without being limited as such, each of the voltage sensor and the temperature sensor may be provided for each of a plurality of cells, or may be provided for only one battery assembly.

The monitoring IC generates a signal (hereinafter, also referred to as a “BMS signal”) indicating the state of the battery 11 using detection signals from the various sensors, and outputs the generated BMS signal to the ECU 150. The ECU 150 acquires, for example, a temperature, a current, a voltage, a state of charge (SOC), and a state of health (SOH) of the battery 11 based on the BMS signal. The monitoring IC may have a function of equalizing cell voltages.

The vehicle 100 further includes a charger 61 and a charging relay 62. The charger 61 and the charging relay 62 are located between the inlet 60 and the battery 11. Each of the charger 61 and the charging relay 62 is controlled by the ECU 150. In this embodiment, a charging line including the inlet 60, the charger 61, and the charging relay 62 is connected between the SMR 12 and the PCU 22. Without being limited as such, a charging line may be connected between the battery 11 and the SMR 12.

The charger 61 charges the battery 11 using electric power input to the inlet 60 from the outside of the vehicle. The charger 61 includes a power conversion circuit (for example, an inverter) and is configured to adjust a charging current. The power conversion circuit performs DC (direct current)/AC (alternating current) conversion. The charging relay 62 switches between connection and disconnection of an electric path from the inlet 60 to the battery 11. The vehicle 100 further includes a detector 61a that monitors the state of the charger 61. The detector 61a includes various sensors (e.g., a current sensor and a voltage sensor) that detect the state of the charger 61, and outputs detection results to the ECU 150.

In the vehicle 100 in the plug-in state, external charging (that is, charging of the battery 11 by electric power from the outside of the vehicle) is possible. Power for external charging is supplied from the power grid PG to the inlet 60 through the charging cable 320 of the EVSE 300. The charger 61 converts the AC power received by the inlet 60 into DC power suitable for charging the battery 11, and outputs the DC power to the battery 11. When the external charging is executed, the charging relay 62 is brought into the closed state (connected state), and when the external charging is not executed, the charging relay 62 is brought into the open state (disconnected state).

The MG 20 is, for example, a three-phase AC motor generator. The MG 20 functions as a traveling motor of the vehicle 100. The MG 20 is driven by the PCU 22 to rotate the drive wheels of the vehicle 100. The MG 20 performs regenerative power generation and outputs the generated power to the battery 11. The vehicle 100 further includes a motor sensor 21 that monitors the state of the MG 20. Motor sensor 21 includes various sensors (e.g., a current sensor, a voltage sensor, and a temperature sensor) that detect the state of MG 20, and outputs the detection results to ECU 150. The number of traveling motors included in the vehicle 100 is arbitrary, and may be one, two, or three or more. The traveling motor may be an in-wheel motor.

The PCU 22 drives the MG 20 using power supplied from the battery 11. The SMR 12 switches between connection and disconnection of an electric path from the battery 11 to the PCU 22. The PCU 22 includes, for example, an inverter and a converter. Each of the SMR 12 and the PCU 22 is controlled by the ECU 150. The SMR 12 is brought into a closed state (a connected state) when the vehicle 100 travels. The SMR 12 is also closed when power is exchanged between the battery 11 and the inlet 60 (accordingly, outside the vehicle).

The lithium-ion secondary battery discharges and charges through a chemical reaction (battery reaction) at the interface between electrode active material (each of the negative electrode active material and the positive electrode active material) and the electrolyte solution. During charging, a battery reaction that releases lithium ions (Li+) and electrons (e−) is performed on the interface of the positive electrode active material, while a battery reaction that absorbs lithium ions (Li+) and electrons (e−) is performed on the interface of the negative electrode active material. During discharge, a battery reaction takes place in which the release/absorption is reversed. Lithium ions are transferred between the positive electrode sheet and the negative electrode sheet through the separator, whereby the lithium-ion secondary battery is charged and discharged.

When the lithium-ion secondary battery is charged, absorption and diffusion in the negative electrode may not catch up with the supply of lithium ions, and lithium metal may be precipitated on the surface of the negative electrode. When lithium metal is excessively precipitated, the precipitated lithium metal may short-circuit the positive electrode and the negative electrode. Therefore, in charge control of the lithium ion secondary battery, it is desirable to suppress precipitation of lithium metal (hereinafter also referred to as “Li precipitation”) so that lithium metal is not excessively precipitated on the electrode surface (particularly, the negative electrode surface) of the lithium ion secondary battery. For example, the Li precipitation can be suppressed by reducing the charging current. However, when the charging current is reduced, the charging time (time until the charging is completed) becomes longer. Therefore, in this embodiment, the charging current is controlled based on the current boundary value at which Li precipitation easily occurs. According to such control, it is possible to suppress an increase in charging time originating from reducing the charging current more than necessary.

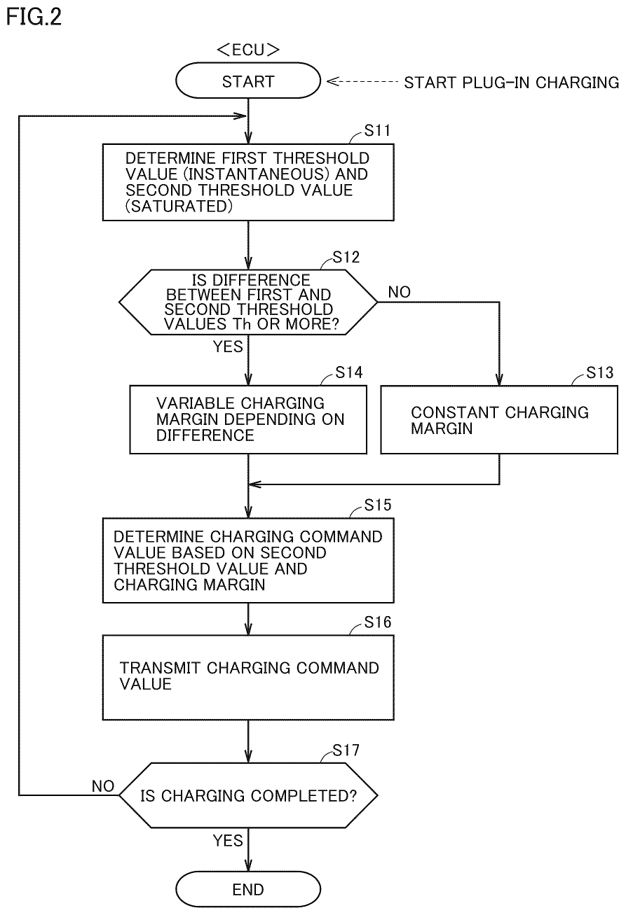

Specifically, the ECU 150 controls the charging current using the first threshold value and the second threshold value by executing a series of processes illustrated in FIG. 2 described below. The first threshold value represents a current boundary value at which Li precipitation becomes likely to occur when the charging current of the battery 11 exceeds the first threshold value. The second threshold value is smaller than the first threshold value, and represents a current boundary value at which Li precipitation becomes likely to occur when the charging current of the battery 11 continuously exceeds the second threshold value. The ECU 150 may acquire the charging current of the battery 11 using at least one of the detection result of the current sensor of the BMS 1la and the detection result of the current sensor of the detector 6la.

FIG. 2 is a flowchart showing a charging method according to this embodiment. The process shown in this flowchart is executed by the ECU 150. The processing flow illustrated in FIG. 2 is started, for example, when a start condition of external charging is satisfied with respect to the vehicle 100. The start condition of the external charging may be satisfied when the vehicle 100 is in the plug-in state. In addition, in the vehicle 100 in which the timer charging is reserved in the ECU 150, the start condition of the external charging may be satisfied when the start time of the timer charging arrives in the plug-in state.

Referring to FIG. 2, in S11, ECU 150 determines a first threshold value and a second threshold value. The first threshold value defines a range of charging current in which Li precipitation can occur in the battery 11. That is, when the charging current of the battery 11 exceeds the first threshold value even instantaneously, there is a high possibility that Li precipitation occurs. Such a first threshold value is likely to fluctuate according to the state of the battery 11. The ECU 150 variably sets the first threshold value using, for example, a first map. For example, the first map is obtained experimentally and stored in the storage device 153. The ECU 150 may set the first threshold based on the voltage and the temperature of the battery 11. For example, when the voltage and the temperature of the battery 11 are input, the first map outputs a first threshold value. A representative value (for example, an average value, a median value, or a maximum value) of data obtained for each of a plurality of cells constituting the battery 11 (battery assembly) may be used as the value (voltage and temperature) of the battery 11. Instead of the first map, a learned model obtained by machine learning using artificial intelligence (AI) may be employed.

The second threshold value defines a range of charging current in which Li precipitation is always suppressed in the battery 11. That is, as long as the charging current of the battery 11 does not exceed the second threshold value, Li precipitation does not occur during charging of the battery 11. However, when the current load continues and the final charging current (saturated charging current) exceeds the second threshold value, there is a high possibility that Li precipitation occurs. The variation in the second threshold value due to the change in the state of the battery 11 is small. Therefore, the second threshold may be a fixed value. For example, a fixed value (second threshold value) obtained experimentally may be stored in the storage device 153. Alternatively, ECU 150 may variably set the second threshold value using, for example, a second map. The ECU 150 may decrease the second threshold value as the thickness of the SEI (Solid Electrolyte Interphase) coating of the negative electrode increases. For example, when the thickness of the SEI film formed on the negative electrode surface is input, the second map outputs a second threshold value. For example, the second map may be obtained experimentally and stored in the storage device 153.

In S12, the ECU 150 determines whether or not the difference between the first threshold value and the second threshold value is equal to or greater than a predetermined reference value (hereinafter, referred to as “Th”). The ECU 150 subtracts the second threshold from the first threshold to obtain a difference (hereinafter, “difference X”) between the first threshold value and the second threshold value. When difference X is smaller than Th (NO in S12), ECU 150 determines a predetermined value (hereinafter referred to as “Mx”) as the charging margin in S13. Mx is a fixed value. In this case, the charging margin is uniformly determined. Mx is set so that the charging current does not exceed the second threshold value during charging of the battery 11 even when the performance of the charger 61 is low, for example, in consideration of variation in the performance of the charger 61. When difference X is equal to or larger than Th (YES in S12), ECU 150 determines a charging margin depending on difference X, within a range smaller than Mx in S14.

Specifically, the ECU 150 variably sets the charging margin so that the charging margin decreases as the difference X increases.

As the difference (difference X) between the first threshold value and the second threshold value increases, precipitation of lithium metal tends to be less likely to occur. When the difference X is smaller than Th, it is considered that precipitation of lithium metal is likely to occur. Therefore, in S13, Mx is determined as the charging margin. On the other hand, when the difference X is larger than Th, it is considered that precipitation of lithium metal is unlikely to occur. Therefore, in S14, the charging current of the battery 11 is increased by making the charging margin smaller than Mx. Further, in S14, the charging margin is decreased as the difference

X increases, and the charging current is increased as the lithium metal is less likely to be precipitated.

After the charging margin is determined in S13 or S14, the ECU 150 determines the charging command value based on the determined charging margin and the second threshold value in S15. The charging command value indicates a target charging current value. The ECU 150 determines the target charging current value so that the charging current of the battery 11 becomes lower than the second threshold value by the charging margin. The ECU 150 obtains the target charging current value by subtracting the charging margin from the second threshold value.

By setting the charging margin as described above, even when the charging control of the lithium ion battery is performed using a charger having low performance, the precipitation of lithium metal can be more reliably suppressed. In addition, by determining the charging margin using the difference between the first threshold value and the second threshold value, it is possible to increase the charging current of the lithium ion battery when it is determined, based on the difference, that precipitation of lithium metal is less likely to occur while executing the charging control of the lithium ion battery so that the charging current of the lithium ion battery does not exceed the second threshold value.

In S16, the ECU 150 transmits the charging command value determined in S15 to the charger 61. The charger 61 that has received the charging command value controls the charging current of the battery 11 so that the charging current of the battery 11 approaches the target charging current value indicated by the charging command value. As a result, the battery 11 is externally charged.

In subsequent S17, the ECU 150 determines whether or not the charging end condition is satisfied. The charging end condition is satisfied, for example, when the amount of power stored in the battery 11 reaches a target value. The target value may be automatically set by the ECU 150 or the EVSE 300, or may be set by the user. The amount of stored power may be represented by SOC. The target value may be a value indicating full charge. Note that the charging end condition can be appropriately changed. For example, the charging end condition may be satisfied when a predetermined time has elapsed from the start of the external charging. In addition, the charging end condition may be satisfied in response to a charging stop instruction from the user.

When the charging end condition is not satisfied (NO in S17), the process returns to the first step (S11). As a result, the external charging is continued. On the other hand, when the charging end condition is satisfied (YES in S17), the processing flow ends. As a result, the external charging ends.

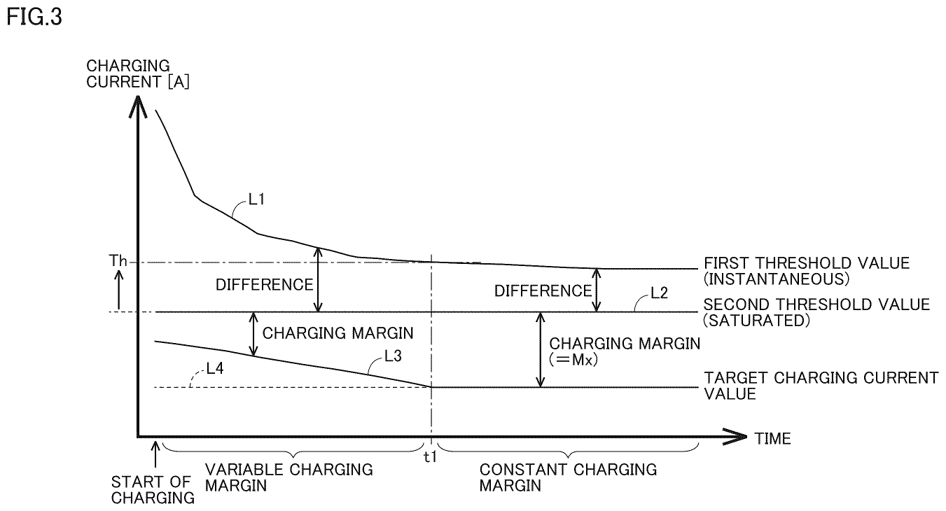

FIG. 3 is a time chart showing an operation example of the charging method shown in FIG. 2. In FIG. 3, lines L1, L2, and L3 indicate transitions of a first threshold value, a second threshold value, and a target charging current value (charging command value) in the charging method shown in FIG. 2, respectively. In the example shown in FIG. 3, the second threshold value is constant. In the charging method shown in FIG. 2, the ECU 150 variably controls the charging current of the battery 11 until the difference X (=first threshold value−second threshold value) falls below Th from the start of charging of the battery 11. In the example shown in FIG. 3, the difference X falls below Th at timing t1. After the difference X falls below Th, the ECU 150 maintains the charging current of the battery 11 at the determined target charging current value (=second threshold−Mx) based on the second threshold.

In the lithium ion battery, as shown in FIG. 3, the difference between the first threshold value and the second threshold value becomes large immediately after the start of charging, the difference becomes small with the lapse of time, and then the difference tends to converge to a constant value. In the charging method shown in FIG. 2, the charging current of the lithium ion battery is variably controlled in a period in which the difference between the first threshold value and the second threshold value immediately after the start of charging of the lithium ion battery is large. Since lithium metal is unlikely to precipitate in such a period, as a result of variably controlling the charging current of the lithium ion battery using a charger with low responsiveness, precipitation of lithium metal is suppressed even if the charging current of the lithium ion battery does not sufficiently follow the target value. In the charging method shown in FIG. 2, the charging current of the lithium ion battery is maintained at the target value determined based on the second threshold value in a period in which the difference between the first threshold value and the second threshold value is small. Therefore, the charging current of the lithium ion battery can easily follow (maintain) the target value even with a charger having low responsiveness.

As described above, the charging method according to this embodiment includes the processes shown in FIG. 2. The charging method includes determining, for the charging current of the lithium ion battery (battery 11), a first threshold value and a second threshold value at which lithium metal is precipitated on the electrode of the lithium ion battery (S11), and controlling the charging current of the lithium ion battery using a difference between the first threshold value and the second threshold value, and the second threshold value (S12 to S16). The ECU 150 (controller) executes the charging method for the battery 11 (lithium ion battery).

Hereinafter, a charging method according to this embodiment will be described in comparison with a comparative example. As a first comparative example, it is conceivable to control the charging current of the lithium ion battery based on the first threshold value regardless of the difference between the first threshold value and the second threshold value. However, in such a charging method, depending on the responsiveness of the charger, there is a possibility that the charging current of the lithium ion battery cannot follow the first threshold value that changes from moment to moment. As a second comparative example, as indicated by a line L4 in FIG. 3, it is conceivable to maintain the charging current of the lithium ion battery at the target charging current value (=second threshold-Mx) determined based on the second threshold, regardless of the difference between the first threshold value and the second threshold value. However, in such a charging method, the charging current of the lithium ion battery always becomes small, and the charging time (time until charging is completed) becomes long.

In the charging method according to this embodiment, the charging current of the lithium ion battery is controlled by using the second threshold value. By controlling the charging current of the lithium ion battery so as not to exceed the second threshold value, precipitation of lithium metal is easily suppressed. Since the variation of the second threshold value over time is small, it is possible to make the charging current of the lithium ion battery follow the second threshold value even with a charger having low responsiveness. In addition, in a lithium ion battery, as the difference between the first threshold value and the second threshold value increases, precipitation of lithium metal tends to be less likely to occur. Therefore, in the charging method, the charging current of the lithium ion battery is controlled by using such a difference in addition to the second threshold value. According to such a charging method, it is possible to shorten the charging time by performing the charging control of the lithium ion battery so that the charging current of the lithium ion battery does not exceed the second threshold value, and increasing the charging current of the lithium ion battery when it is determined based on the difference that precipitation of lithium metal is difficult to occur. Even if the performance of the charger 61 mounted on the vehicle 100 is low, the ECU 150 can accurately suppress precipitation of lithium metal in charging the battery 11. The ECU 150 (controller) may be configured to select a charging method from options including the charging method shown in FIG. 2, the charging method according to the first comparative example, and the charging method according to the second comparative example, and execute the selected charging method.

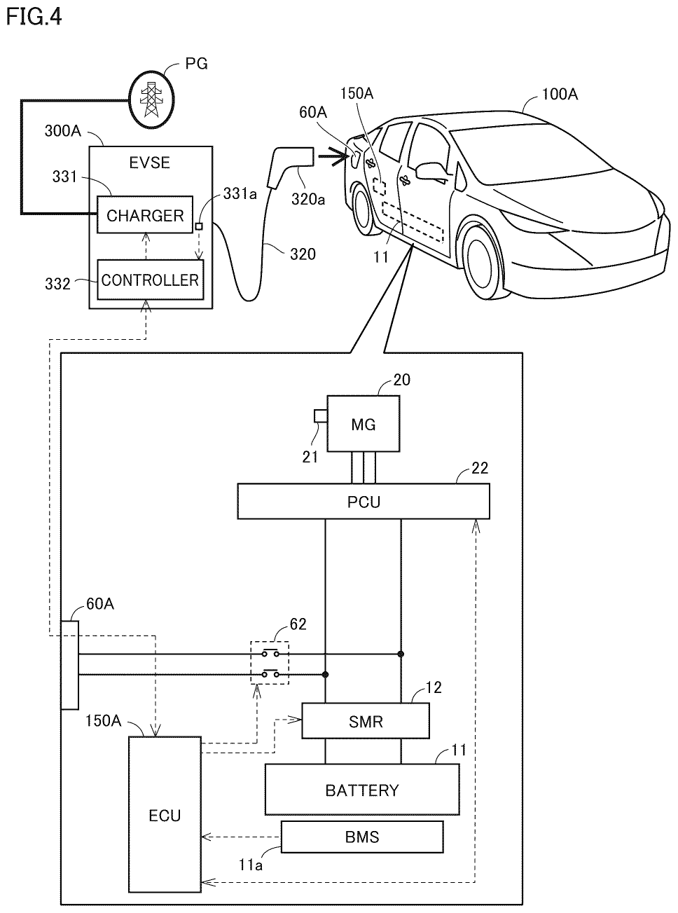

In the above embodiment, the charging control of the lithium ion battery is performed using the charger 61 mounted on the vehicle 100. Without being limited as such, charging control of the lithium ion battery may be performed using a charger mounted on the EVSE. FIG. 4 is a diagram showing a modification of the charging system shown in FIG. 1.

Referring to FIG. 4, EVSE 300A incorporates charger 331, detector 33la, and controller 332. The charger 331 includes a power conversion circuit (for example, an inverter) and is configured to adjust a charging current. The detector 331a includes various sensors (e.g., a current sensor and a voltage sensor) that detect the state of the charger 331, and outputs the detection results to the controller 332. When the connector 320a of the EVSE 300A is connected to the inlet 60A of the vehicle 100A, the vehicle 100A enters a plug-in state. In the vehicle 100A in the plug-in state, the ECU 150A performs external charging of the battery 11 while communicating with the controller 332 via the charging cable 320. During external charging, the charger 331 converts AC power supplied from the power grid PG into DC power and outputs the DC power to the connector 320a. That is, the EVSE 300A outputs DC power. The DC power output from the EVSE 300A to the vehicle 100A is input to the inlet 60A to charge the battery 11.

The ECU 150A performs external charging of the battery 11 by the charging method shown in FIG. 2. In S16, the ECU 150A transmits the charging command value determined in S15 to the controller 332. The controller 332 that has received the charging command value controls the charger 331 so that the charging current of the battery 11 approaches the target charging current value indicated by the charging command value. As a result, the battery 11 is externally charged. The controller 332 may acquire the charging current by using the detection result of the current sensor of the detector 331a.

The processing flow illustrated in FIG. 2 can be appropriately changed. For example, the order of processing may be changed or unnecessary steps may be omitted depending on the purpose. Further, the contents of any of the processes may be changed. For example, in the processing flow shown in FIG. 2, when the difference X matches Th, the processing proceeds to S14, but the processing flow may be changed to proceed to S13.

The configuration of the vehicle is not limited to the configuration described above (see FIG. 1). For example, the vehicle may be configured to be wirelessly chargeable. A vehicle that performs wireless charging may be considered to be in a state conforming to the above-described “plug-in state” when alignment between a power transmission unit (for example, a power transmission coil) on the power supply facility side and a power reception unit (for example, a power reception coil) on the vehicle side is completed.

The lithium ion battery may be mounted on a resource other than an automobile. The resource may be mobile object (railway vehicle, ship, airplane, drone, walking robot, robot cleaner, etc.) other than an automobile. The resources may be electromechanical equipment (lighting devices, air conditioning equipment, cooking equipment, televisions, refrigerators, washing machines, etc.). The lithium ion battery to be charged may be a stationary lithium ion battery used in a building (home, factory, etc.) or outdoors.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A charging method comprising:
determining, for charging current of a lithium ion battery, a first threshold value and a second threshold value each representing a current boundary value at which precipitation of lithium metal becomes likely to occur on an electrode of the lithium ion battery; and
controlling the charging current of the lithium ion battery using a difference between the first threshold value and the second threshold value, and the second threshold value, wherein
the first threshold value represents a current boundary value at which precipitation of the lithium metal becomes likely to occur when the charging current of the lithium ion battery exceeds the first threshold value, and
the second threshold value is a value smaller than the first threshold value, and represents a current boundary value at which precipitation of the lithium metal becomes likely to occur when the charging current of the lithium ion battery continuously exceeds the second threshold value.

2. The charging method according to claim 1, wherein
controlling the charging current includes:
determining a charging margin using the difference between the first threshold value and the second threshold value;
determining a target charging current value at which the charging current of the lithium ion battery is lower by the charging margin than the second threshold value; and
controlling the charging current of the lithium ion battery to cause the charging current to approach the target charging current value.

3. The charging method according to claim 2, wherein
controlling the charging current includes:
determining whether the difference between the first threshold value and the second threshold value is larger than a reference value;
determining, when the difference between the first threshold value and the second threshold value is smaller than the reference value, a predetermined value as the charging margin; and
determining, when the difference between the first threshold value and the second threshold value is larger than the reference value, the charging margin so that the charging margin is smaller than the predetermined value and the charging margin decreases as the difference between the first threshold value and the second threshold value increases.

4. The charging method according to claim 1, wherein
controlling the charging current includes:
variably controlling the charging current of the lithium ion battery, from start of charging of the lithium ion battery to a time when the difference between the first threshold value and the second threshold value becomes smaller than a predetermined value; and
maintaining, after the difference becomes smaller than the predetermined value, the charging current of the lithium ion battery at a target charging current value determined based on the second threshold value.

5. A charging system comprising:
a lithium ion battery; and
a controller that performs, for the lithium ion battery, the charging method according to claim 1.
